(19) United States
(12) Patent Application Publication
(10) Pub. No.: US 2006/0196971 A1
(43) Pub. Date: Sep. 7, 2006

(54) Shower head

(76) Inventor: Ping Wa Lau, Hong Kong (HK)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/069,582

(22) Filed: Mar. 1, 2005

(51) Int. Cl. A62C 31/00

(52) U.S. Cl. 239/436; 239/437; 239/442

(57) ABSTRACT

A shower head comprises a head chamber 10, a water inlet 2 for the supply of water into the chamber and a water outlet 1 including a plurality of openings 11 for the outlet of water from the chamber. A rotor 3 is mounted for continuous rotation within the chamber under the action of water passing through the chamber. The rotor is mounted adjacent the outlet openings 11 and, at any one rotary position thereof, closes some but not all of the openings whereby each of the openings is intermittently opened and closed by rotation of the rotor. In a second embodiment, a plurality of rotors are provided.

The invention relates to shower heads and in particular to a shower head in which water is delivered in a broken rather than continuous stream to give an effect like raining from a plurality of outlets.

In U.S. Pat. No. 4,579,284 a spray head contains a rotor which is turned by the flow of water and axially reciprocates to alternately open and restrict the water flow passageway through the spray head to provide a pulsating spray. A similar arrangement is provided in U.S. Pat. No. 6,648,245.

The present invention provides a shower head in which a plurality of outlet openings are intermittently opened and closed by one or more rotating devices such that at any one time, some of the openings are open and some are closed. The spray of water produced by the shower head of the present invention has a gentle massaging effect and gives a soft and comfortable feeling to the user.

In a first form, the invention provides a shower head comprising: a head chamber; a water inlet for the supply of water into the chamber; a water outlet including a plurality of openings for the outlet of water from the chamber; and a rotor mounted for continuous rotation within the chamber under the action of water passing through the chamber; wherein the rotor is mounted adjacent the outlet and, at any one rotary position thereof, closes some but not all of the openings; whereby each of the openings is intermittently opened and closed by steady rotation of the rotor.

In a second form, the invention provides a shower head comprising: a head chamber; a water inlet for the supply of water into the chamber; a water outlet including a plurality of openings for the outlet of water from the chamber, the openings being arranged in a plurality of groups; and a plurality of rotors, each associated with one of the groups of openings, mounted for continuous rotation within the chamber under the action of water passing through the chamber; wherein the rotors are mounted adjacent the outlet and wherein each rotor, at any one rotary position thereof, closes some but not all of the openings of the associated group; whereby each of the openings is intermittently opened and closed by steady rotation of the associated rotor.

Embodiments of the invention are described below with reference to the accompanying drawings in which:

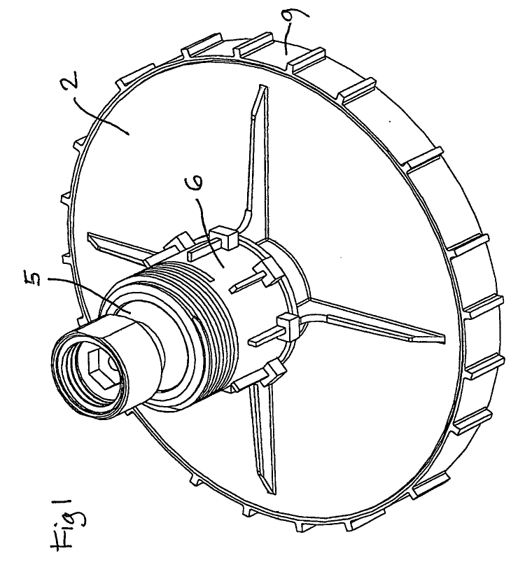

FIG. 1 is a perspective view of a shower head using a single rotor;

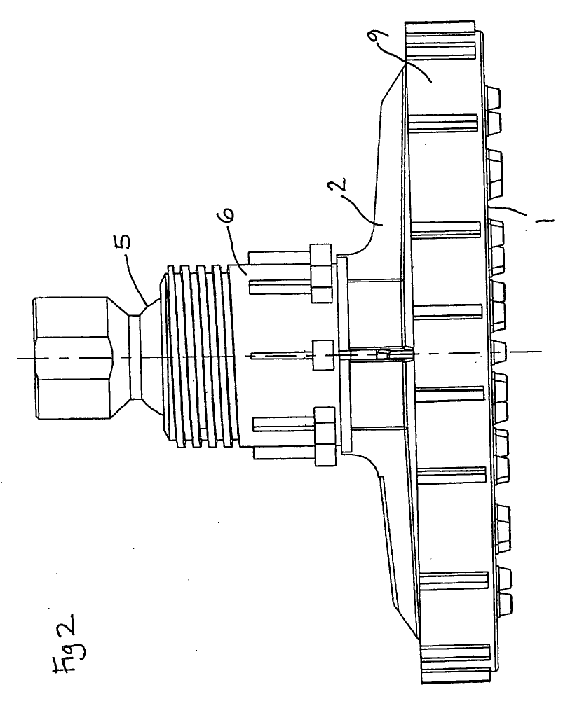

FIG. 2 is a side view of the shower head;

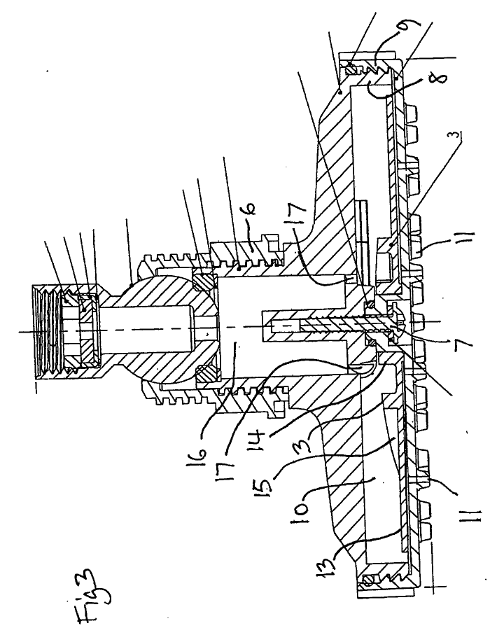

FIG. 3 is a vertical cross section through the shower head;

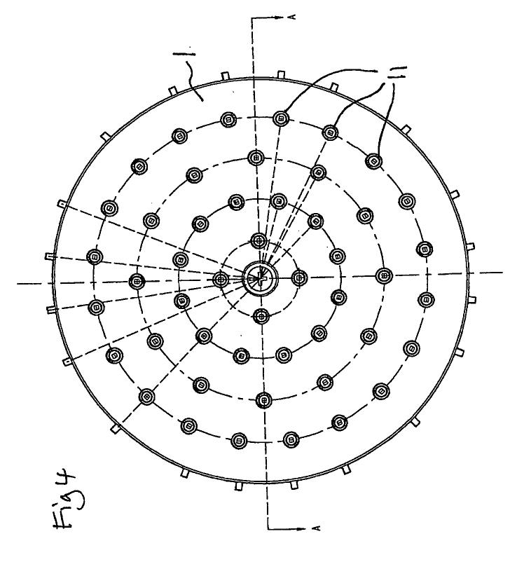

FIG. 4 is an underplan view of the shower head;

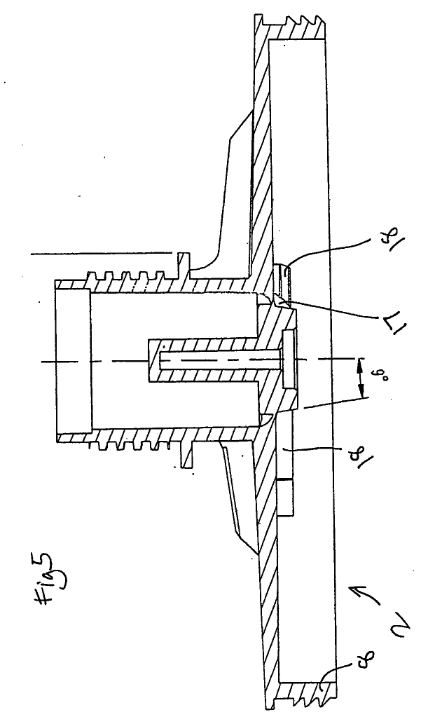

FIG. 5 is a vertical cross section through the waterway of the shower head;

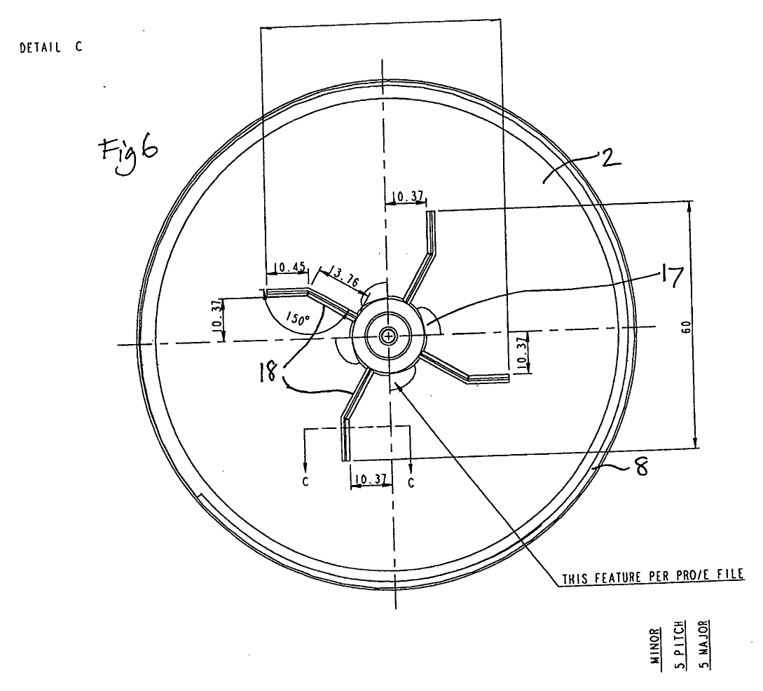

FIG. 6 is an underplan view of the waterway;

FIG. 7 is a perspective view of a faceplate of the shower head;

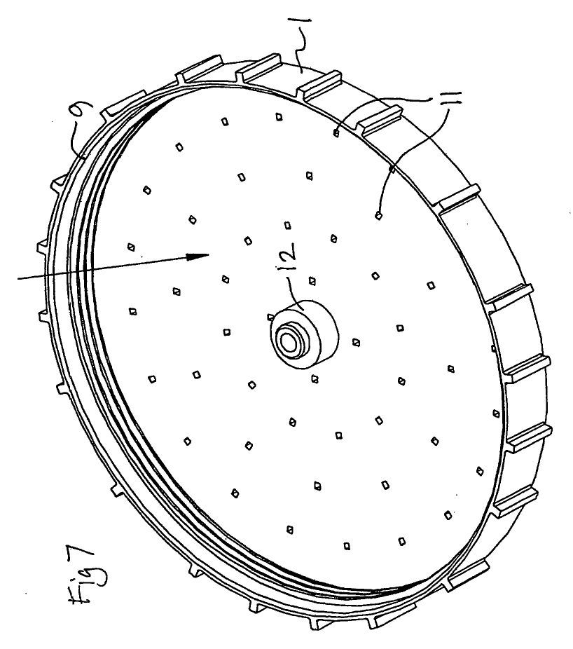

FIG. 8 is a perspective view of the rotor of the shower head;

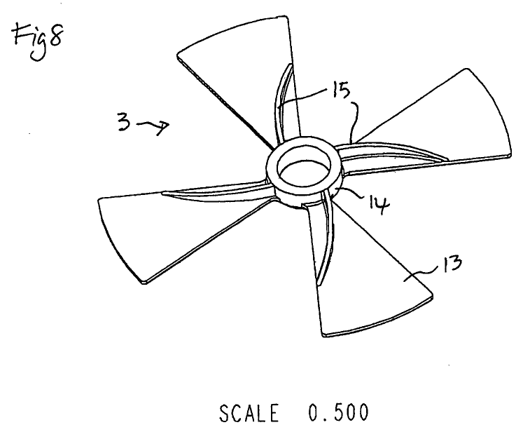

FIG. 9 is a perspective view of a shower head using a plurality of rotors;

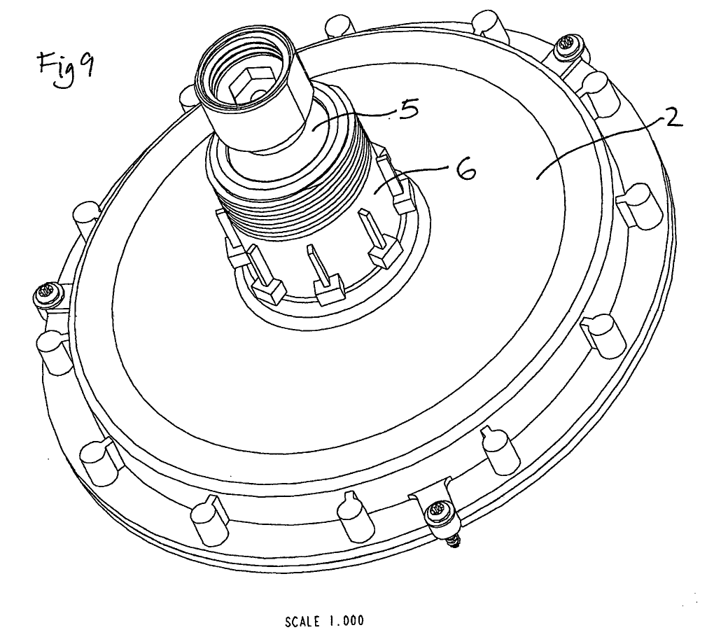

FIG. 10 is a side view of the shower head;

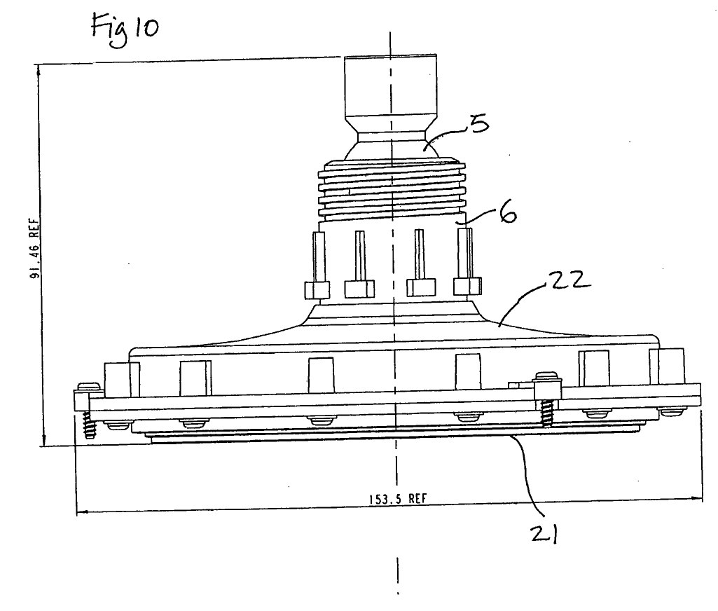

FIG. 11 is a vertical cross section through the shower head;

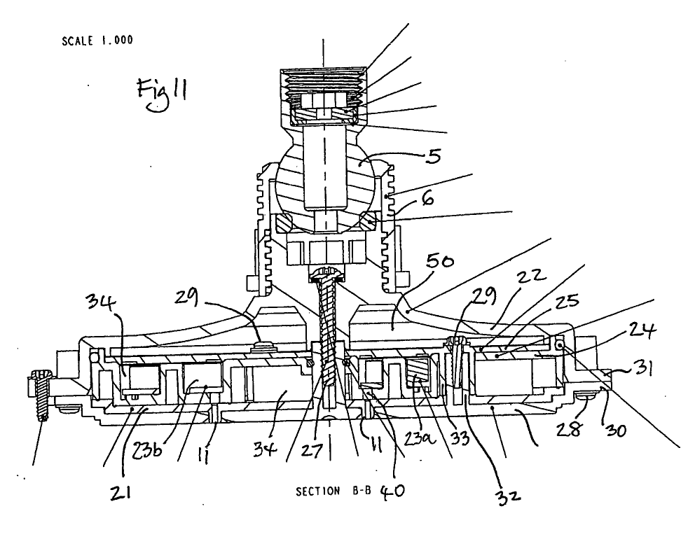

FIG. 12 is an underplan view of the shower head;

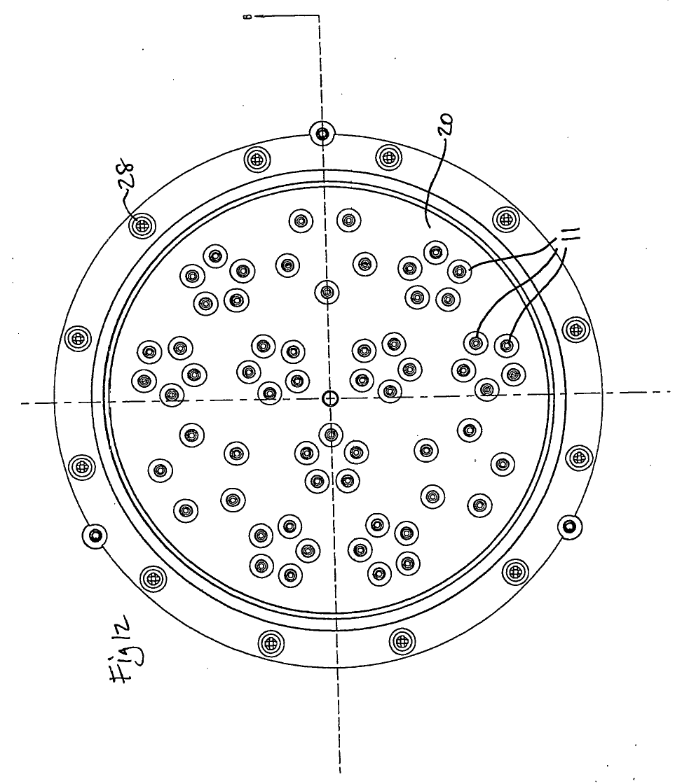

FIG. 13 is a vertical cross section through the waterway of the shower head;

FIG. 14 is a perspective view of a lid of the shower head from above;

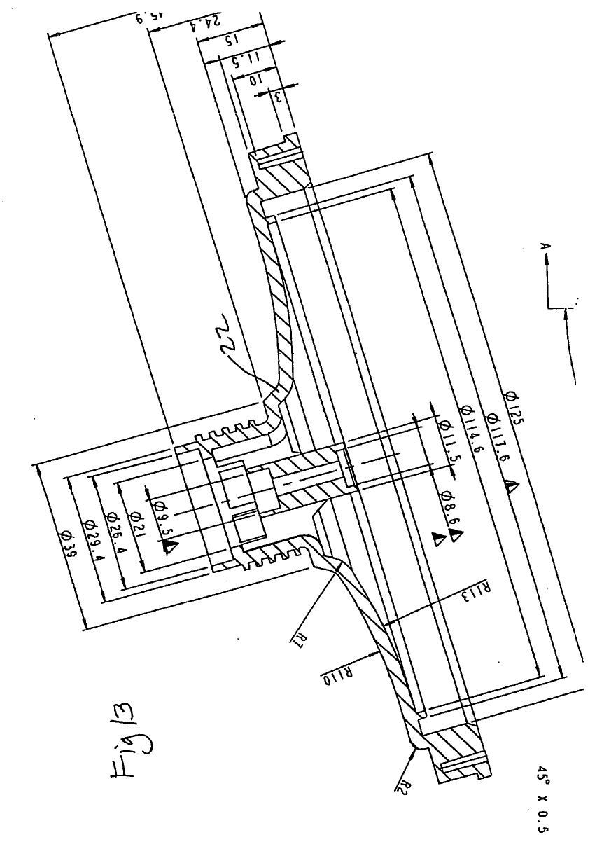

FIG. 15 is a perspective view of the lid from below;

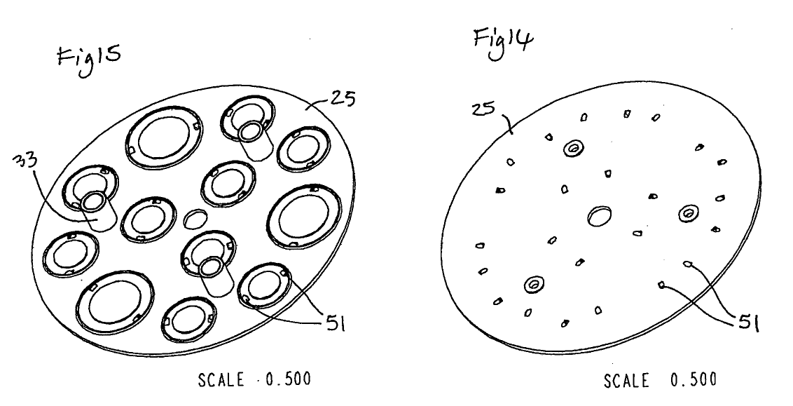

FIG. 16 is a perspective view of a bracket of the shower head from above;

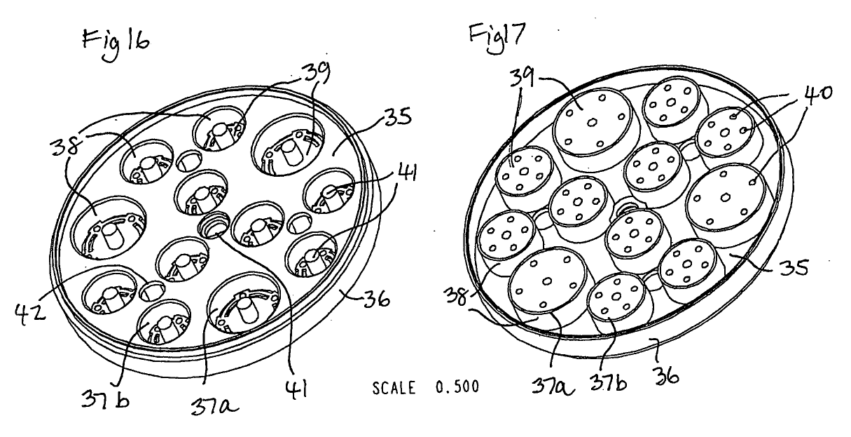

FIG. 17 is a perspective view of the bracket from below;

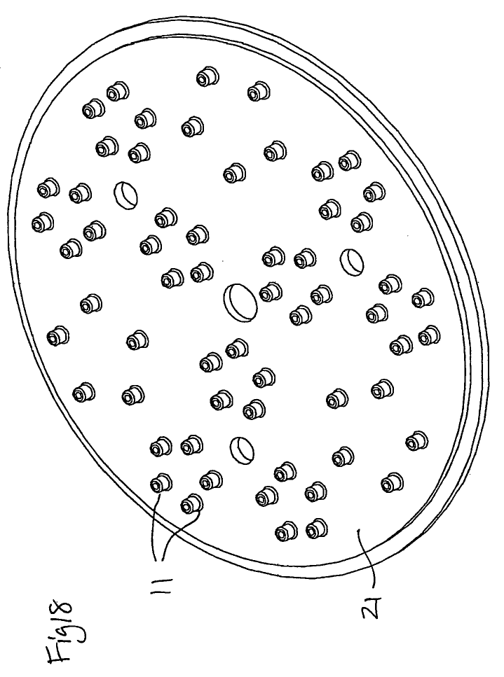

FIG. 18 is a perspective view of the nozzle of the shower head from below;

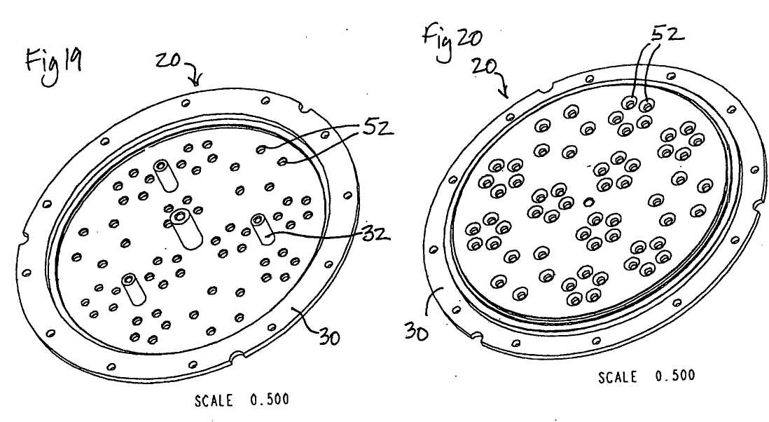

FIG. 19 is a perspective view of the faceplate of the shower head from above;

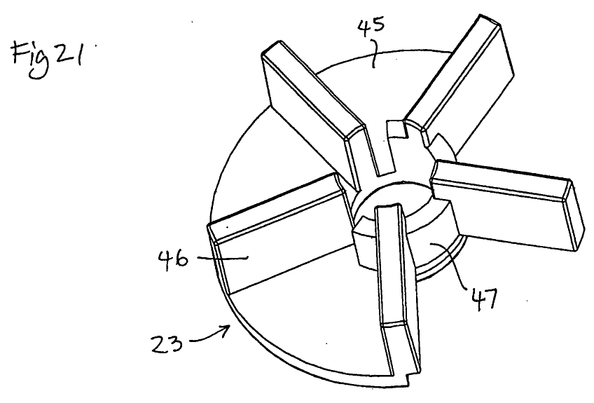

FIG. 20 is a perspective view of the faceplate from below; and

FIG. 21 is a perspective view of a rotor.

A first embodiment of the invention using a single rotor is shown in FIGS. 1-8. The main components of the shower head are faceplate 1, waterway 2, rotor 3, swivel ball 5 and ball holder 6 which are assembled together by means of screw threads and a screw 7 as best seen in FIG. 3. The swivel ball 5 is retained on the waterway 2 by the ball holder 6 which is threaded onto the waterway. The waterway 2 and faceplate 1 have co-operating screw-threaded skirts 8 and 9 and are further held together by the screw 7. The waterway 2 and faceplate 1 together define an enclosed chamber 10. The waterway 2 provides an inlet for the supply of water into the chamber (from a supply connected to the swivel ball) and the faceplate provides a water outlet for the outlet of water from the chamber through a plurality of openings in the faceplate defined by a plurality of spaced nozzles 11 formed in the faceplate.

The faceplate 1 is also formed with a central boss which provides an axle 12 for the rotor 3. The rotor 3 has four flat blades 13 each extending from a central hub 15 and carrying a curved vane. The blades 13 of the rotor closely overlie the upper surface of the faceplate and at any one rotary position thereof the rotor closes some but not all of the openings (nozzles 11) formed in the faceplate.

Water is supplied into the chamber 10 through the swivel ball 5 which can be free to swing at an angle of 20°, an upper bore 16 in waterway 2, and restricted passages 17 provided between the bore 16 and the chamber 10. The passages 17 are steeply inclined to the central axis of the shower head and cause the water entering the chamber 10 to swirl in a circumferential manner around the central axis of the shower head. This action is further assisted by vanes 18 formed on the underside of the waterway and lying in the upper part of the chamber 10. The rotation movement of water in the chamber around the central axis of the shower head causes steady rotation of the rotor 3 on the axle 12 by engagement of the water with the curved vanes 15 upstanding from the blades 13. During rotation of the rotor each one of the openings in the faceplate will be intermittently opened and closed as the blades 13 of the rotor 3 pass over it. If required, further openings (not shown) can be provided in the faceplate beyond the extent of the rotor. Such openings will be permanently open.

A further embodiment of a shower head employing a plurality of rotors is shown in FIGS. 9-20. The major components of this shower head are cover plate 20, faceplate 21, waterway 22, rotors 23a and 23b, a bracket 24, a lid 25, a swivel ball 5 and a ball holder 6. The components are assembled together by means of screw threads and screws 27, 28 and 29 as best seen in FIG. 11. As before, the swivel ball 5 is retained on the waterway 22 by the ball holder 6 which is threaded onto the waterway. The cover plate 20 has a peripheral flange 30 which is coupled to a corresponding peripheral flange 31 on the waterway 22 by means of screws 28. The waterway and cover plate 20 are also coupled by means of a central screw 27. Between the cover plate and the waterway are mounted the faceplate 21, the bracket 24, the lid 25 and the rotors 23a and 23b. The faceplate is mounted immediately above the cover plate, the bracket 24 is mounted immediately above the faceplate 21 and the lid 25 is mounted immediately above the bracket. Hollow posts 32 upstanding on the cover place co-operate with hollow posts 33 depending from the lid to maintain the components in radius alignment. Screws 29 couple the components axially. The space between the waterway 22 and the faceplate 21 defines an enclosed chamber 34 which contains the lid 25, the bracket 24 and the rotors 23.

The waterway 22 provides an inlet for the supply of water into the chamber 34 (from a supply connected to the swivel ball) and the faceplate 21 provides a water outlet for the outlet of water from the chamber 34 through a plurality of openings in the faceplate defined by a plurality of spaced nozzles 11 formed in the faceplate.

The bracket 24 is best seen in FIGS. 11, 16 and 17 comprises a circular upper plate 35 and a peripheral skirt 36 and supports a plurality of recessed cylindrical rotor chambers 37a and 37b. Each rotor chamber has a cylindrical wall 38, a base wall 39 formed with a plurality of openings 40 and a boss 41 upstanding from the base wall to provide axles for the rotors. The bracket also has a central opening 41 and three further openings 42 which are provided for the passage through the bracket of the hollow posts and screws referred to above for fixing the components together. The rotor chambers 37a are larger than the rotor chambers 37b and house rotors 23a which are larger than the rotors 23b housed in the chambers 37b. A perspective view of a rotor 23 is shown in FIG. 21. The rotors 23a and 23b are identical except in size and each comprises a flat part circular blade 45 and a plurality of vanes 46 mounted around a central hub 47. The rotors are journalled in the rotor chambers for rotation on the bosses 41. The blades 45 closely overlie the openings 40 in the base walls 39 of the rotor chambers 37 and at any one rotary position thereof they close some but not all of the openings 40. As shown, the rotors close three of the five openings in their respective chambers at any one time. Each opening 40 is in register with a nozzle 11 in the faceplate 21 so that when the blades 45 close an opening 40 they are consequently closing a corresponding opening (nozzle 11) in the faceplate 21.

Water is supplied into the chamber 34 through the swivel ball 5, a plurality of passages in the waterway leading to a plenum chamber 50, and the lid 25 which is formed with a plurality of openings 51 for this purpose. The openings 51 in the lid, the openings 40 in the bracket, and the openings 11 in the faceplate are arranged in groups. As shown, two openings 51 in the lid supply water into each rotor chamber which has a group of five openings 40 in its base wall. The openings 51 are set close to the rotors in annular recesses 53 and are inclined such that water exiting from them drives the rotors 23. The openings from each rotor chamber are in register with a group of five nozzles 11 in the faceplate.

The openings 51 in the lid are steeply inclined to the central axis of the shower head and direct water tangentially into each rotor chamber adjacent its outer periphery so that the water tends to swirl circumferentially around the rotor chamber. This rotation movement of the water in the rotor chambers around the axes of the chambers causes steady rotation of the rotors 37 on the axles 41 by virtue of engagement of the water with the vanes 46. During rotation of each rotor each one of the openings 40 in the group of openings associated with that rotor will be intermittently opened and closed as the blade 45 of the rotor passes over it. This in turn has the effect of each of the nozzles 11 in the corresponding group of nozzles being intermittently opened and closed such that water exiting from each nozzle will be formed as a series of drops rather than a continuous stream, thus creating a raindrop effect. All the rotors are in a random position and therefore the water coming out of the nozzles will be similar to natural raindrops.

The cover plate 20, shown in FIGS. 19 and 20, if formed with a plurality of holes 52 which receive the nozzles 11 depending from the faceplate 21.

1. A shower head having a plurality of outlet openings and one or more rotating devices within the shower head which intermittently open and close the openings such that at any one time, some of the openings are open and some are closed.

2. A shower head comprising;
a head chamber;
a water inlet for the supply of water into the chamber;
a water outlet including a plurality of openings for the outlet of water from the chamber; and
a rotor mounted for continuous rotation within the chamber under the action of water passing through the chamber; wherein the rotor is mounted adjacent the outlet and, at any one rotary position thereof, closes some but not all of the openings; whereby each of the openings is intermittently opened and closed by steady rotation of the rotor.

3. A shower head as claimed in claim 2, wherein the water inlet comprises a waterway adapted to be connected to a supply of water and the water outlet comprises a faceplate formed with a plurality of nozzles providing the openings for the outlet of water from the chamber and wherein the rotor is journaled for rotation on the faceplate.

4. A shower head as claimed in claim 3, wherein means are provided in the waterway to deliver water into the chamber with a motion causing rotation of the rotor.

5. A shower head as claimed in claim 3, wherein the rotor is formed with a plurality of flat blades which overlie the faceplate, each flat blade carrying an upstanding vane.

6. A shower head comprising:
a head chamber;
a water inlet for the supply of water into the chamber;
a water outlet including a plurality of openings for the outlet of water from the chamber, the openings being arranged in a plurality of groups and,
a plurality of rotors, each associated with one of the groups of openings, mounted for continuous rotation within the chamber under the action of water passing through the chamber;
wherein the rotors are mounted adjacent the outlet and wherein each rotor, at any one rotary position thereof, closes some but not all of the openings of the associated group; whereby each of the openings is intermittently opened and closed by steady rotation of the associated rotor.

7. A shower head as claimed in claim 6, wherein the water inlet comprises a waterway adapted to be connected to a supply of water and the water outlet comprises a faceplate formed with a plurality of nozzles providing the openings for the outlet of water from the chamber and wherein the chamber contains a bracket which divides the chamber into a plurality of cylindrical rotor chambers each supporting one of the plurality of rotors for rotation therein.

8. A shower head as claimed in claim 7, wherein a lid is provided in the shower head above the bracket and wherein the lid is formed with openings for the passage of water therethrough into each of the rotor chambers; the openings being adapted to direct water into the rotor chambers such that the motion of water causes rotation of the rotors.

9. A shower head as claimed in claim 7, wherein each rotor chamber is formed with a base wall having a plurality of openings, each in register with a nozzle in the faceplate, and wherein the rotor is formed with at least one flat blade which overlies the faceplate and carries at least one upstanding vane.

10. (canceled)
